(19) United States
(12) Patent Application Publication
(10) Pub. No.: US 2015/0009329 A1
(43) Pub. Date: Jan. 8, 2015

(54) DEVICE FOR MONITORING SURROUNDINGS OF MACHINERY

(71) Applicant: HITACHI CONSTRUCTION MACHINERY CO., LTD., Tokyo (JP)

(72) Inventor: Hidefumi Ishimoto, Tsuchiura-shi (JP)

(73) Assignee: HITACHI CONSTRUCTION MACHINERY CO., LTD., Tokyo (JP)

(21) Appl. No.: 14/352,026

(22) PCT Filed: Oct. 1, 2012
(86) PCT No.: PCT/JP2012/075424

§ 371 Date: Apr. 15, 2014

(30) Foreign Application Priority Data
Oct. 18, 2011 (JP) 2011-228893

(51) Int. Cl. B60R 1/00; B60R 11/04; H04N 7/18

(52) U.S. Cl. CPC B60R 1/002; H04N 7/181; B60R 11/04; B60R 2300/105; B60R 2300/607; B60R 2300/802
USPC 348/148

(57) ABSTRACT

A surroundings monitoring device (200) provided on machinery which changes its vehicle body height. The surroundings monitoring device includes a plurality of cameras (30) that image the surroundings thereof, a unit for converting the original images (31) taken by the cameras (30) to overhead viewpoint images (35), a unit for combining the overhead viewpoint images (35) to generate a bird's-eye image (300), a unit for displaying the bird's-eye image (300), and a unit for detecting the positions of the cameras. The bird's-eye image-generating unit adjusts the display region (e) for each overhead viewpoint image (35) on the basis of the detected height of the camera concerned, and combines the overhead viewpoint images. It is therefore possible to always generate and display an accurate bird's-eye image (300) even when the vehicle body height changes significantly.

### TECHNICAL FIELD

The present invention relates to a device for making a bird's eye image around machinery, such as excavator, power shovel, dump truck, by a plurality of cameras attached to the machinery, in order to monitor the surroundings of the machinery.

### BACKGROUND ART

An excavator or power shovel, which is one kind of construction machine or machinery, generally has a driver seat on the front left side of an upper swinging part. Thus, confirmation by sight (visual recognition) is not easy in the right direction and backward direction of the upper swinging part. To address this problem, Patent Document 1 for example teaches use of cameras which are installed on the right side face and rear portion of the upper swinging part respectively. These cameras captures images in the right direction and backward direction of the upper swinging part, and the captured images are displayed on a monitor at the driver's seat so as to ensure the visual recognition in the right direction and backward direction.

Patent Document 1 also teaches a device for monitoring the surrounding that uses a plurality of cameras provided on a vehicle body or frame to capture images around the vehicle. The captured images undergo an upper viewpoint conversion process and are synthesized, and the synthesized image is then combined with an image of the surrounding, with the image representative of the machinery being at the center. The viewpoint of this composite image converted to over the top of the vehicle body or frame, and therefore a bird's eye view image is obtained. This bird's eye view image is displayed on the monitor at the driver's seat, and a driver can sensuously recognize the distance between the vehicle body (frame) and substances in its surrounding such as obstacles.

### LISTING OF PRIOR ART REFERENCES

### Patent Documents

Patent Document 1: Japanese Patent Application Publication (Kokai) No. 2008-95307

### SUMMARY OF THE INVENTION

### Problem(s) to be Solved

The machinery such as excavator or power shovel may change its height significantly depending upon working environments and a changed suspension system (base portion). For example, if the machinery is equipped with outriggers for stabilization of its vehicle body or frame, and the outriggers are actuated, the vehicle body generally increases its height several cm (centimeters) or more than ten cm. When a suspension system or base portion of the shovel is altered, or when a tire size is altered, the same thing will occur, i.e., the height changes to a certain extent. In case of other types of machinery such as dump truck, the vehicle body height may significantly change with a weight of loadage.

If the device for monitoring the surrounding disclosed in Patent Document 1 is applied to the machinery that often changes its vehicle body (frame) height greatly, the positions (heights) of the cameras for photographing the surrounding images of the vehicle body also change and therefore an image of an appropriate bird's eye view may not be displayed.

The present invention is proposed to overcome these problems, and an object of the present invention is to provide a novel device for monitoring the surroundings of machinery that can always prepare an appropriate bird's eye view image and display it even if the vehicle body (frame) height significantly changes.

### Solution For Overcoming the Problems

In order to address the above-described problems in accordance with a first aspect of the present invention, there is provided a surroundings monitoring device installed on machinery that changes its vehicle body or frame height. The surroundings monitoring device (device for monitoring the surroundings of machinery) includes a plurality of cameras mounted on the vehicle body (frame) of the machinery for photographing (or video-taping) the surroundings of the machinery, upper viewpoint image preparation means for applying an upper viewpoint conversion process on an original image, which is photographed by each of the cameras, to prepare an upper viewpoint image of each camera, bird's eye view image preparation means for synthesizing the upper viewpoint images, which are prepared by the upper viewpoint image preparation means, to prepare a bird's eye image of the surroundings which includes an image representing the machinery, display means for displaying the bird's eye view image prepared by the bird's eye view image preparation means, and camera position detection means for detecting the positions of the cameras mounted on the vehicle body (frame). The bird's eye view image preparation means synthesizes display regions of the upper viewpoint images, which are prepared by the upper viewpoint image preparation means, based on the height of each of the cameras detected by the camera position detection means.

With such configuration, when the images photographed by the cameras undergo the upper viewpoint conversion process and are synthesized to prepare a bird's eye view image of the surroundings, including an image representative of the machinery, the display regions of the upper viewpoint images are synthesized on the basis of the camera heights respectively. Accordingly, even if the vehicle body (frame) height changes greatly, it is always possible to prepare and display an appropriate bird's eye view image. It should be noted that the height of the camera in this specification is a vertical distance from the ground surface to the camera, if the ground surface is, for example, used as the reference plane.

According to a second aspect of the present invention, there is provided a device for monitoring the surroundings of machinery defined by the first aspect, further including a range finder for measuring the vertical distance between the ground surface, on which the vehicle body (frame) stands, and the camera, wherein the camera position detection means detects the camera position based on the vertical distance between the ground surface and the camera which is measured by the range finder.

Because the surroundings monitor device having such configuration can measure the vertical distance between the ground surface on which the vehicle body (frame) is present and the camera, it is possible to easily and accurately calculate the positions of the cameras provided on the vehicle body (frame).

According to a third aspect of the present invention, there is provided a device for monitoring the surroundings of machinery defined by the first aspect, further including an input part for entry of vehicle body (frame) information, wherein the camera position detection means detects the camera positions based on the vehicle body information entered from the input part.

Because the surroundings monitor device having such configuration can obtain the height of the vehicle body (frame) based on the vehicle body information such as a tire size, it is possible to easily calculate the positions of the cameras provided on the vehicle body.

According to a fourth aspect of the present invention, there is provided a device for monitoring the surroundings of machinery defined by the first aspect, further including a gravimeter for measuring a weight of loadage on the vehicle body, wherein the camera position detection means detects the camera positions based on the weight of the loadage measured by the gravimeter.

With such configuration, it is possible to know (obtain) the height decrease of the vehicle body by measuring the weight of the loadage with the gravimeter. Thus, the positions of the cameras mounted on the vehicle body are easily calculated.

### Advantages of the Invention

According to the present invention, when a bird's eye view image of the surroundings, including an image of machinery, is prepared by applying an upper viewpoint conversion process on the images captured by the cameras and synthesizing them, the display areas of the respective upper viewpoint images are adjusted based on the respective camera heights and then synthesized. Therefore, even if the vehicle body (frame) height alters greatly, it is still possible to always prepare and display an appropriate bird's eye view image.

### BRIEF DESCRIPTION OF THE DRAWINGS

FIG. 1 is a general perspective view of an excavator or power shovel 100, which is one kind of machinery, according to one embodiment of the present invention.

FIG. 2 is a block diagram of a surroundings monitor device 200 according to the embodiment of the present invention.

FIG. 3 is a conceptual view showing an example of a photographing area of each of cameras 30 mounted on a vehicle body.

FIG. 4 is a conceptual view showing an example of preparing upper viewpoint images 35 from captured images and synthesizing the upper viewpoint images.

FIGS. 5a to 5c are a series of views showing image processing to correct lens distortion in an original photographed image 31 and convert the viewpoint of the image.

FIG. 6 is a conceptual view depicting an example of a bird's eye view image 300 prepared when the cameras are situated at their home positions.

FIG. 7a schematically illustrates an exemplary bird's eye view image 300 prepared when the camera positions are higher than the home positions.

FIG. 7b schematically illustrates an exemplary bird's eye view image 300 prepared when the camera positions are lower than the home positions.

FIG. 8 is a flowchart showing a series of processing carried out by the surroundings monitor device 200 of the present invention.

FIGS. 9a to 9c are a series of views useful to explain exemplary changes of the camera positions when the machinery is a power shovel 100.

FIGS. 10a and 10b are views useful to explain exemplary changes of the camera positions when the machinery is a power shovel 100 equipped with outriggers 40.

FIGS. 11a to 11c are views useful to explain exemplary changes of the camera positions when the machinery is a dump truck 400.

FIGS. 12a and 12b are views useful to explain exemplary changes of the camera positions when the machinery is a power shovel 100 equipped with four crawlers.

### MODE FOR CARRYING OUT THE INVENTION

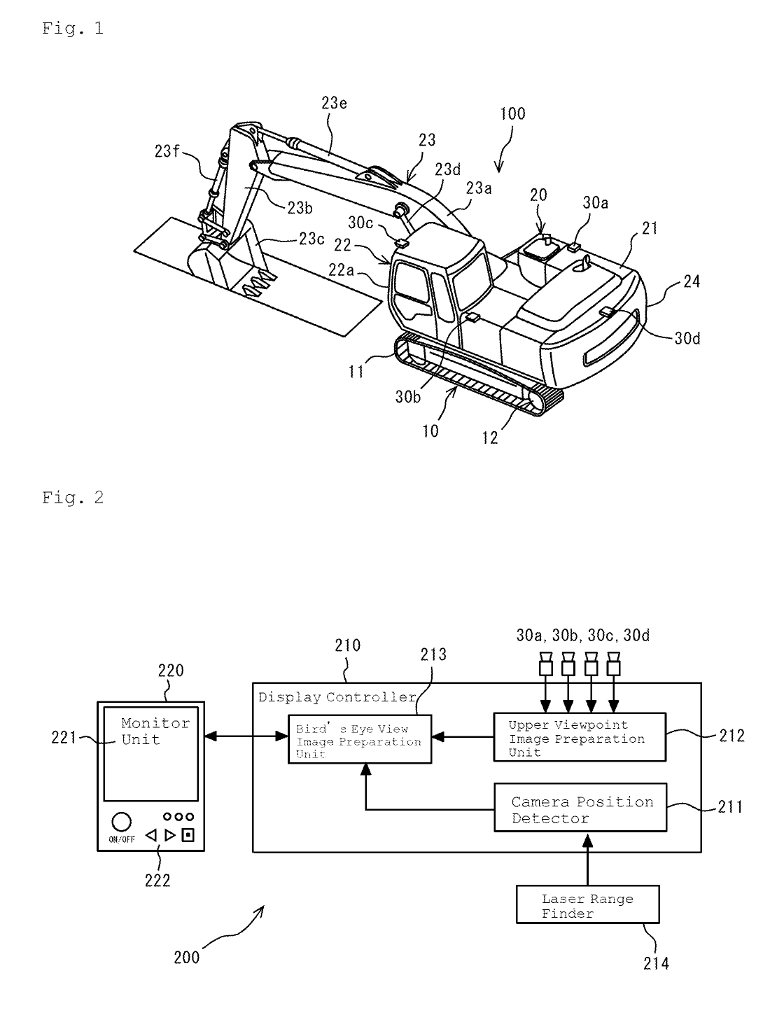

Now, embodiments of the present invention will be described with reference to the accompanying drawings. FIG. 1 is a general perspective view of an excavator or power shovel 100, which is one kind of machinery according to one embodiment of the present invention. As illustrated, the power shovel 100 has, as its main components, a lower traveling body 10 and an upper swinging body 20 swingably (pivotably) provided on the lower traveling body 10. The lower traveling body 10 has a pair of crawlers 11 (11) that are provided in parallel to each other on a frame (not shown) of the traveling body. Each of these crawlers 11 (11) is equipped with a hydraulically-operated traveling motor 12 for driving an associated crawler belt (track) for traveling.

The upper swinging body 20 has, its main components, an engine room 21 for housing an engine, which is located on the swinging body frame (not shown), as well as various equipment such as a battery and a fuel tank, a driver's cab 22 provided on the left front side of the engine room 21, a front working machine 23 extending forward from the right side of the driver's cab 22, and a counter weight 24 provided behind the engine room 21 to keep the weight balance with the front working machine 23.

The driver's cab 22 has a cabin 22a which an operator (driver) gets on board. In the cabin 22a, an operation lever for operating the front working machine 23 and various meters and gages are installed. A surroundings monitoring display (will be described) is also installed in the cabin 22a. The front working machine 23 has, its main components, a boom 23a extending forward from the swinging body frame, an arm 23b attached pivotably to a front end of the boom 23a, and a bucket 23c attached pivotably to a front end of the arm 23b. The boom 23a, arm 23b and bucket 23c are operated by a boom cylinder 23d, an arm cylinder 23e and a bucket cylinder 23f respectively. The boom cylinder 23d, arm cylinder 23e and bucket cylinder 23f are caused to extend (expand) and contract hydraulically.

Four cameras 30a, 30b, 30c and 30d are installed on both sides of the engine room 21, on top of the driver's cab 22 and on top of a counter weight 24, respectively, such that the four cameras continuously photograph the views in their respective directions. The camera 30a continuously photographs the view on the right side of the upper swinging body 20 with a view angle of 180 degrees. The camera 30a is inclined downward diagonally. The camera 30b continuously photographs the view on the left side of the upper swinging body 20 with a view angle of 180 degrees. The camera 30b is included downwardly diagonally. The camera 30c continuously photographs the view in front of the upper swinging body 20 with a view angle of 180 degrees. The camera 30c is directed diagonally downward. The camera 30d continuously photographs the view behind the upper swinging body 20 with a view angle of 180 degrees. The camera 30d is directed diagonally downward.

As shown in FIG. 2, the images (original images) photographed by the respective cameras 30a, 30b, 30c and 30d are introduced to a display controller 210 of the surroundings monitor device 200 of the present invention. Each of the cameras 30a, 30b, 30c and 30d is, for example, a wide-angle video camera that has an image capturing or pick-up element (e.g., CCD and/or CMOS) which has excellent durability and weather resistance, and a wide-angle lens. In the following description, those portions of the upper swinging body 20 on which the cameras 30a, 30b, 30c and 30d are installed (mounted) are collectively referred to as the vehicle body 20.

FIG. 2 is a block diagram of an exemplary surroundings monitor device 200 provided on the power shovel 100. As illustrated, the surroundings monitor device 200 has, its main components, the display controller 210 and a surroundings monitor display 220. The display controller 210 has a camera position detector 211, an upper viewpoint image preparation unit 212, and a bird's eye view image preparation unit 213. The display controller 210 is configured from an image processing LSI (hardware) that includes a CPU, a RAM, a ROM, an input/output interface and other elements (not shown). The ROM and other memories of the display controller 210 store various data in advance as well as dedicated image processing programs, and the CPU uses such data and programs to cause the respective parts 221-213 to perform their functions.

The camera position detector 211 detects the height of each of the cameras 30a, 30b, 30c and 30d mounted on the vehicle body 20 as described earlier. In other words, the camera position detector 211 detects the vertical distance from the ground on which the vehicle body 20 is present to each of the cameras 30a, 30b, 30c and 30d mounted on the vehicle body 20. The camera position detector 211 then sends the detected heights of the cameras 30a, 30b, 30c and 30d to the bird's eye view image preparation unit 213. Specifically, the camera position detector 211 detects the heights of the cameras 30a, 30b, 30c and 30d based on the measurement values introduced from associated laser range finders 214 as shown in FIG. 2. Preferably the laser range finders 214 are provided in the vicinity of the associated cameras 30a, 30b, 30c and 30d respectively in order to ensure the accurate measuring. It should be noted, however, that if the installation position of the range finder makes the measuring difficult, then such range finer may be mounted on a lower face of the vehicle body 20 for easier measuring. Then, the measurement value of the range finer 214 and the distance (positional relationship) between the laser range finder 214 and the camera concerned (30a, 30b, 30c, 30d) may be taken into account when the distance to a measurement target is calculated.

The upper viewpoint image preparation unit 212 prepares upper viewpoint images from a plurality of original images (four original images), which are photographed by the cameras 30a, 30b, 30c, and 30d, at the rate of 30 frames/second, and sends the prepared upper viewpoint images (video or moving picture) to the birds' eye view image preparation unit 213. Specifically, when the composite signals, such as NTSC signals, of the original images from the cameras 30a, 30b, 30c and 30d are received, the upper viewpoint image preparation unit 212 applies an A/D conversion on the composite signals to have decoded signals (RGB signals), and accumulates them in the dedicated frame memories respectively. Then, the upper viewpoint image preparation unit 212 carries out a lens distortion correcting process, and applies a known image transformation processing such as a plane projective transformation with a homography matrix or projection processing in a three-dimensional space to shift the viewpoints of the original images to the upper viewpoints, thereby obtaining the upper viewpoint images.

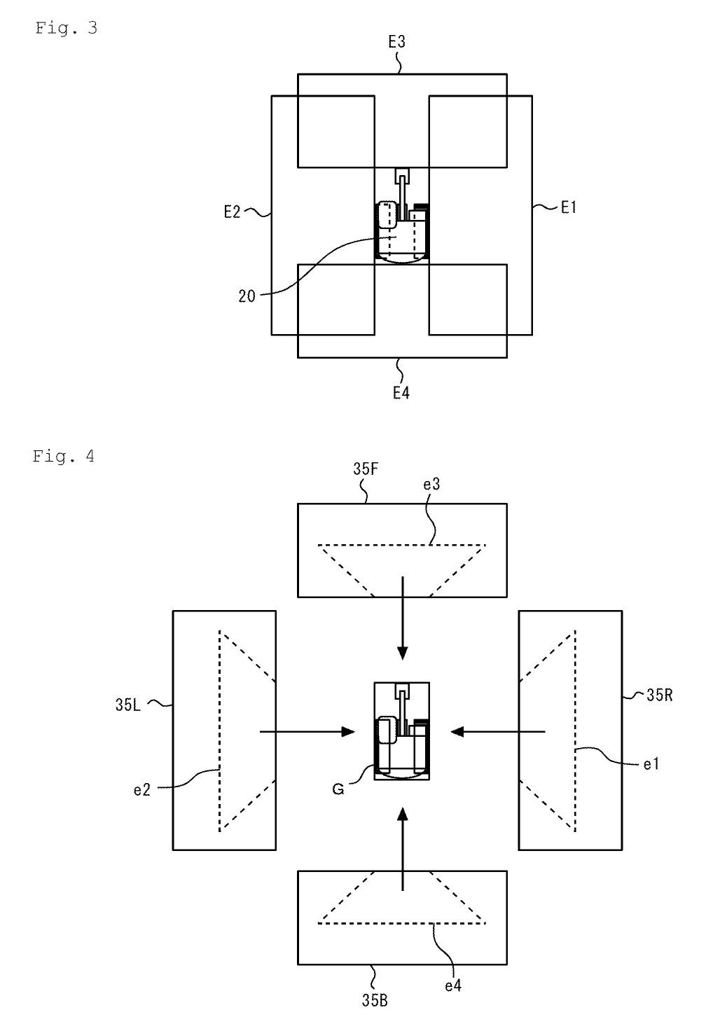

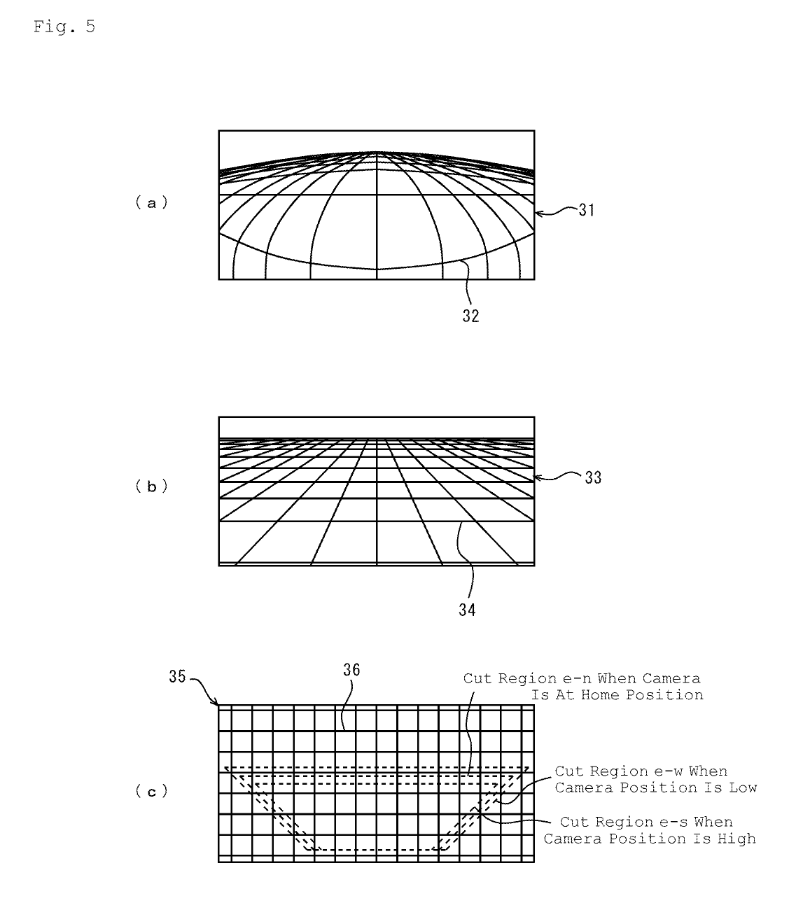

FIG. 3 and FIGS. 5a-5c illustrate views useful to describe the transformation processing of the upper viewpoint images in the upper viewpoint image preparation unit 212. Referring firstly to FIG. 3, rectangular areas E1, E2, E3 and E4 around the vehicle body 20 indicate regions that can be photographed by the cameras 30a, 30b, 30c and 30d of the vehicle body 20 respectively. The rectangular regions E1, E2, E3 and E4 overlap the neighboring regions at both end portions, and these overlapping portions are photographed by the respective cameras.

FIG. 5a shows an original image 31 of the rectangular region E1, E2, E3, E4 photographed by the camera 30a, 30b, 30c, 30d. Because the view is photographed with a wide-angle lens, the original image 31 is generally distorted such that the center portion is enlarged and the peripheral portions are reduced as indicated by the grid lines. FIG. 5b shows an after-correction image 33, which is obtained by applying a lens distortion correction in the upper viewpoint image preparation unit 212. The distorted image is corrected to the image 33 in accordance with the perspective, such that the perspective view from the viewpoint of the camera 30a, 30b, 30c, 30d is provided, as indicated by hypothetical vertical-horizontal coordinate 34 on the ground (road surface). The lens distortion correction may be carried out with, for example, a pixel coordinate transformation process using a dedicated pixel transformation table. The transformation table may be stored in a memory in advance and describe the relationship between the addresses of the pixels of the image before transformation and the addresses of the pixels after transformation.

FIG. 5c depicts the upper viewpoint image (overhead viewpoint image) 35, which is obtained by applying the viewpoint change process on the ground (road surface) image 33 obtained by the lens distortion correction process (FIG. 5b). The upper viewpoint image 35 after the viewpoint change process has a viewpoint shifted from the vehicle body to the above-the-vehicle-body, and the hypothetical coordinate 34 of FIG. 5b is transformed to a hypothetical rectangular coordinate 36. The viewpoint change process may be performed by a pixel coordinate transformation process with a dedicated pixel transformation table, which is stored in a memory in advance.

The bird's eye view image preparation unit 213 takes (cuts) an image to be displayed, from the upper viewpoint image 35, and synthesizes four such images to prepare a bird's eye view image (video) of the surroundings, with an image representative of the machinery being at the center. In FIG. 5c, a trapezoidal region e, enclosed by the broken line, is an example of the cut image e prepared by the bird's eye view image preparation unit 213 when the bird's eye view image preparation unit cuts the image e from the given image to prepare the image e to be displayed in a synthesized image. The overlapping portions of the four upper viewpoint images 35 are removed when the four cut images are synthesized to prepare a single composite image which is easy to see. As shown in FIG. 4, the bird's eye view image preparation unit 213 combines the four cut images e1-e4 of the four upper viewpoint view images 35, with the image G representative of the power shovel 100 being at the center, and the four cut images surrounding the image G. In this manner, the bird's eye view image preparation unit prepares a single continuous bird's eye view image 300 of the surroundings of the vehicle body, and sends its image data to the frame memory.

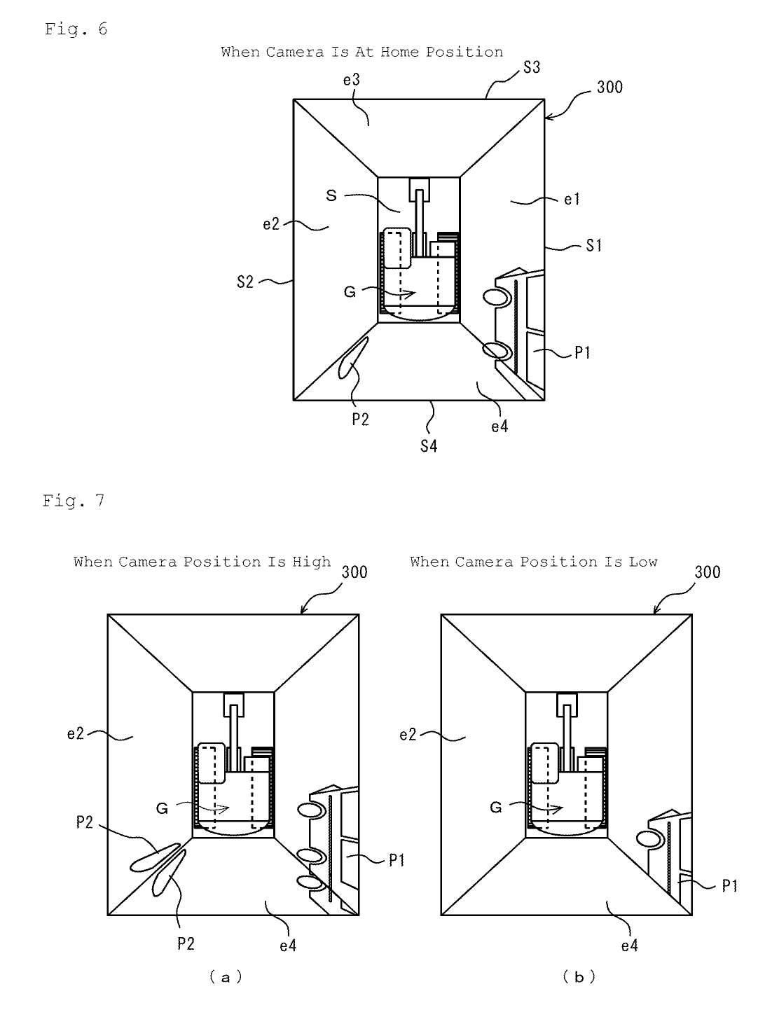

FIG. 6 is an example of the bird's eye view image 300 prepared by the bird's eye view image preparation unit 213. At the center of the drawing, a rectangular display area S is provided for displaying the vehicle body image G which corresponds to the power shovel 100. The image G is prepared in advance. With this display area S being at the center, four independent trapezoidal display areas S1-S4 are formed on the right and left as well as in front of and behind the center display area S. The four trapezoidal cut images e1-e4 obtained from the four upper viewpoint images 35 are displayed in the four display areas S1-S4, respectively.

The cut image e1 derived from the upper viewpoint image 35R, which is obtained from the right side photographed image of the upper swinging body 20 photographed by the camera 30a (FIG. 4) is displayed in the display area S1. The cut image e2 derived from the upper viewpoint image 35L, which is obtained from the left side photographed image of the upper swinging body 20 photographed by the camera 30b is displayed in the display area S2. The cut image e3 derived from the upper viewpoint image 35F, which is obtained from the front photographed image of the upper swinging body 20 photographed by the camera 30c is displayed in the display area S3. The cut image e4 derived from the upper viewpoint image 35B, which is obtained from the backward photographed image of the upper swinging body 20 photographed by the camera 30d is displayed in the display area S4. In the bird's eye view image 300 of FIG. 6, there is a vehicle P1 in the diagonally right rear direction of the power shovel 100 and there is a pole P2 in the diagonally left rear direction of the power shovel 100. It is seen that the vehicle P1 and pole P2 are situated several meters distant from the rear end of the power shovel 100 respectively.

The surroundings monitor display 220 receives and displays the bird's eye view image 300 of the entire surroundings of the vehicle body, which is prepared by the bird's eye view image preparation unit 213. Specifically, the surroundings monitor display 220 stores the data of the received bird's eye view image (composite image) 300 in an output frame memory, encodes the data (RGB signals) of this composite image to a composite signal, applies a D/A conversion process onto the composite signal and displays it on the display unit 221. The surroundings monitor display 220 has an input unit 222 in addition to the display unit 221, and an operator uses the input unit 222 to perform various operations, such turning on and off the power, enlarging, reducing and rotating the composite image on the display screen, altering the region to be displayed, changing the photographing mode to a normal mode and changing the display mode to a dual screen mode.

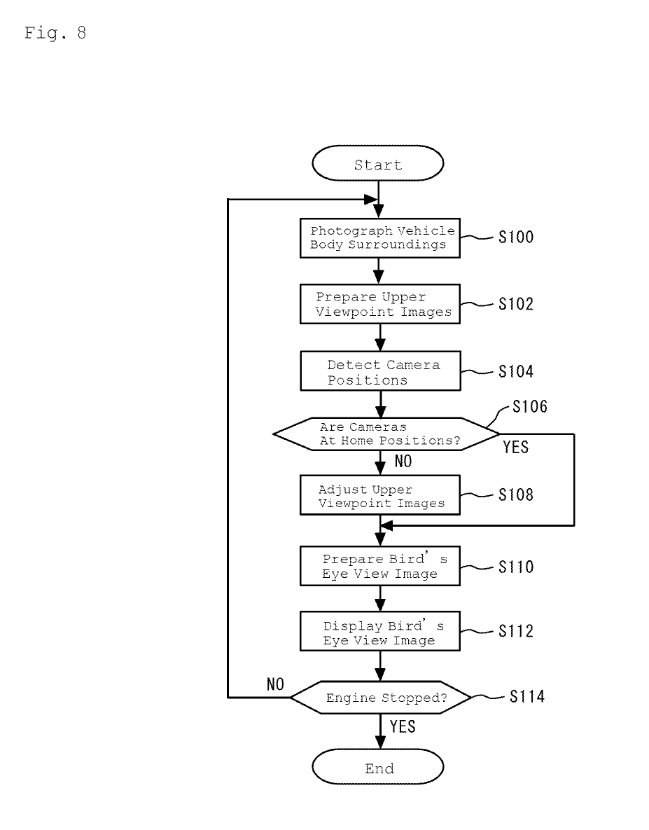

The operation of the surroundings monitor device 200 of the present invention having the above-described structure will be now described with primarily reference to the flowchart shown in FIG. 8. Firstly, the display controller 210 of the surroundings monitor device 200 is powered on when the engine of the power shovel 100 is started up. The display controller performs the initial system check, and if no abnormality is found, the display controller proceeds to Step S100. At Step S100, the surroundings of the vehicle body are photographed by the four cameras 30a, 30b, 30c and 30d mounted in the four directions of the vehicle body 20 as described earlier, and the images of the surroundings are obtained. Then, the display controller proceeds to Step S102.

At Step S102, the four original photographed images 31 undergo the upper viewpoint conversion process to prepare the four upper viewpoint images 35, and these upper viewpoint images are connected to prepare the bird's eye view image 300 with the vehicle body image G being at the center as shown in FIG. 6. Then, the display controller proceeds to Step S104. At Step S104, the camera position detector 211 of the display controller 210 detects the heights (vertical distance from the ground surface) of the cameras 30a, 30b, 30c and 30d, which are detected by the laser range finders 214, and proceeds to Step S106.

At Step S106, it is determined whether the detected heights of the cameras 30a, 30b, 30c and 30d are the predetermined heights or within the predetermined ranges. The center values in the predetermined ranges are the predetermined heights. The predetermined range for each camera is referred to as a home position of that camera. If it is determined that the camera is at its home position (YES), the display controller jumps to Step S110. If it is determined that the camera is not at the home position (NO), then the display controller goes to the next step, Step S108. At Step S108, adjustments are made to the upper viewpoint images because the image to be displayed will have discrepancy when the heights of the cameras 30a, 30b, 30c and 30d are not the home positions.

FIG. 7a illustrates an example of the bird's eye view image 300 when the camera positions are higher than the home positions. FIG. 7b illustrates an example of the bird's eye view image 300 when the camera positions are lower than the home positions. As shown in FIG. 7a, when the camera positions are higher than the home positions, the photographing areas of the respective cameras become larger than when the cameras are at their home positions. As a result, the upper viewpoint cut images e overlap each other at the coupling areas of these images e. In the example of FIG. 7a, two poles P2 are displayed at the coupling area between the rear cut image e4 and the left cut image e2 although there is in reality only one pole P2. On the other hand, when the camera positions are lower than the respective home positions as shown in FIG. 7b, then the photographing areas of the cameras become smaller than when the cameras are at the home positions. Thus, some portions of the images will not be displayed (certain portions of the images will be missing) at the coupling areas between the upper viewpoint cut images e. In the example of FIG. 7b, the pole P2 is not displayed (or is difficult to see) at the coupling area between the rear cut image e4 and the left cut image e2 although the pole P2 should be displayed at that coupling area.

Therefore, when it is determined at Step S106 that the detected heights of the cameras 30a, 30b, 30c and 30d are not their home positions, the size of each of the cut images e, which is enclosed by the broken line as shown in FIG. 5c, is altered based on the detected height. Specifically, when the height of the camera 30 is lower than the home position, a larger cut region e-w is selected. The cut region e-w is larger than the cut region e-n for the camera 30 being situated at the home position. On the other hand, when the camera position is higher than the home position, the smaller cut region e-s is selected, which is smaller than the cut region e-n. The size of the cut region is decided in accordance with the height of the camera 30, using for example a conversion table that is stored in a memory in advance.

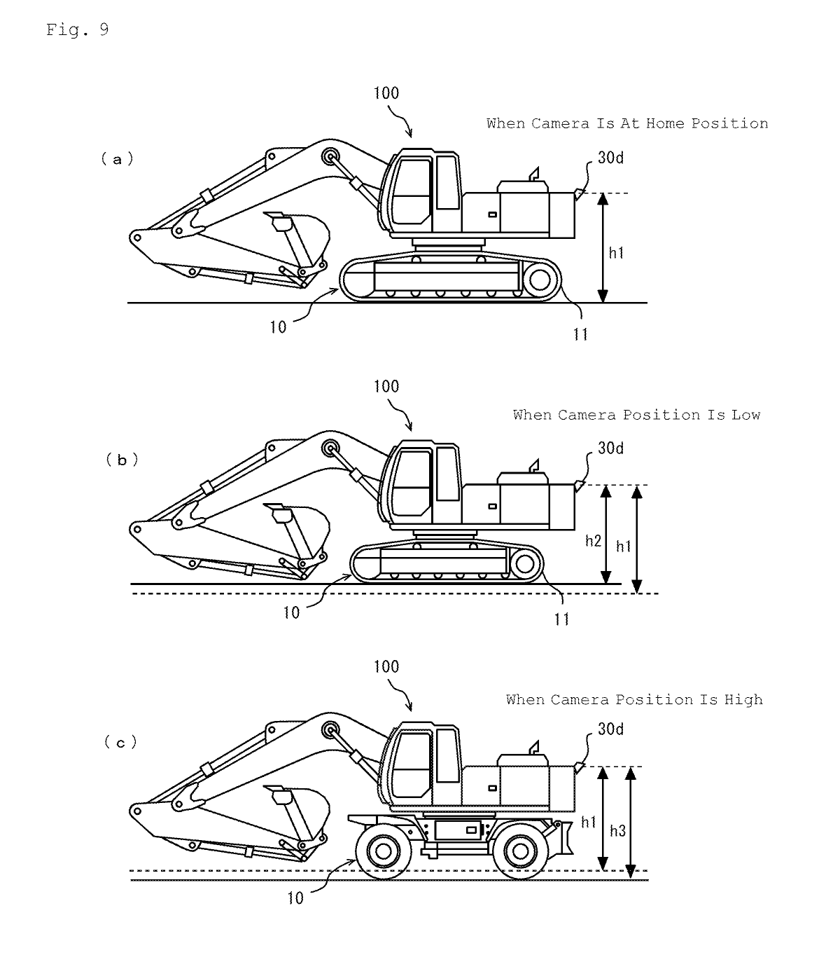

FIGS. 9a-9c, 10a-10b, 11a-11c and 12a-12b show examples when various types of machinery change their heights, respectively. FIG. 9a illustrates an example when the crawlers 11 of the lower traveling body 10 of the crawler-type power shovel 100 have the ordinary size, and FIG. 9b illustrates an example when the crawlers 11 have a smaller size than the ordinary size. Because the height h2 of the camera 30d in FIG. 9b is lower than the height h1 of the camera 30d in FIG. 9a, the cut region e-w is selected in FIG. 5c, which is larger than the cut region e-n for the camera 30d having the home position height. In case of the wheel-type lower traveling body 10 as shown in FIG. 9c, on the other hand, because the height h3 of the camera 30d in FIG. 9c is higher than the height h1 of the camera 30d in FIG. 9a, the cut region e-s is selected in FIG. 5c, which is smaller than the cut region e-n for the camera 30d having the home position height.

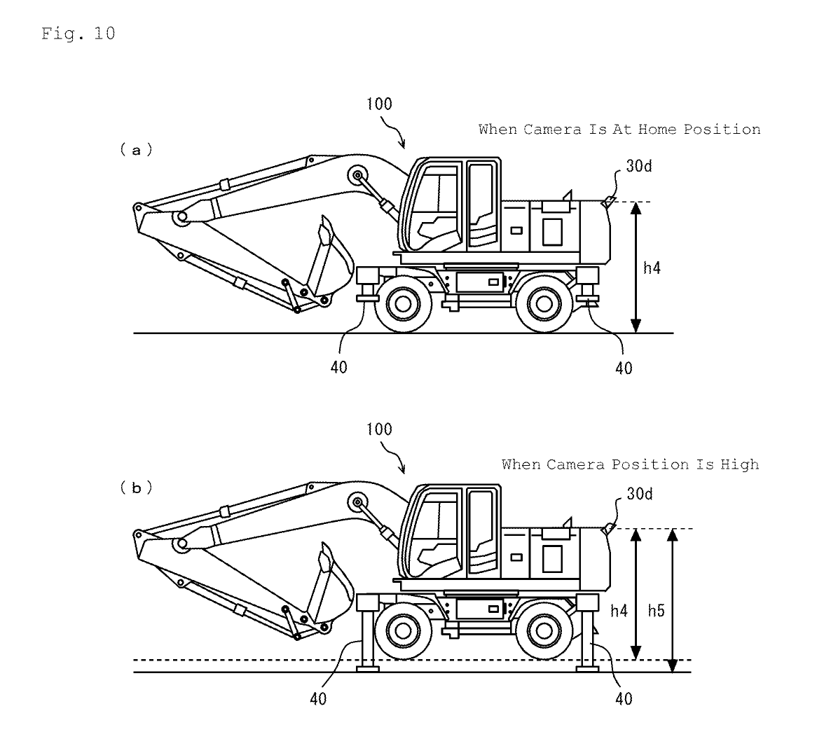

FIGS. 10a and 10b illustrate examples when the machinery is a wheel-type power shovel 100 equipped with outriggers 40. FIG. 10a shows the position (height) of the camera 30d when the outriggers 40 are actuated during operation of the power shovel, and FIG. 10b shows the position (height) of the camera 30d when the outriggers 40 are not actuated during operation of the power shovel. In general, the camera height is h4 when the outriggers 40 are not actuated, and the camera height is h5 when the outriggers 40 are actuated. The camera height h5 is higher than the camera height h4 several cm or more than 10 cm. As such, when the outriggers 40 are actuated, the cut region e-s is selected, which is smaller than the cut region e-n for the outriggers being not actuated.

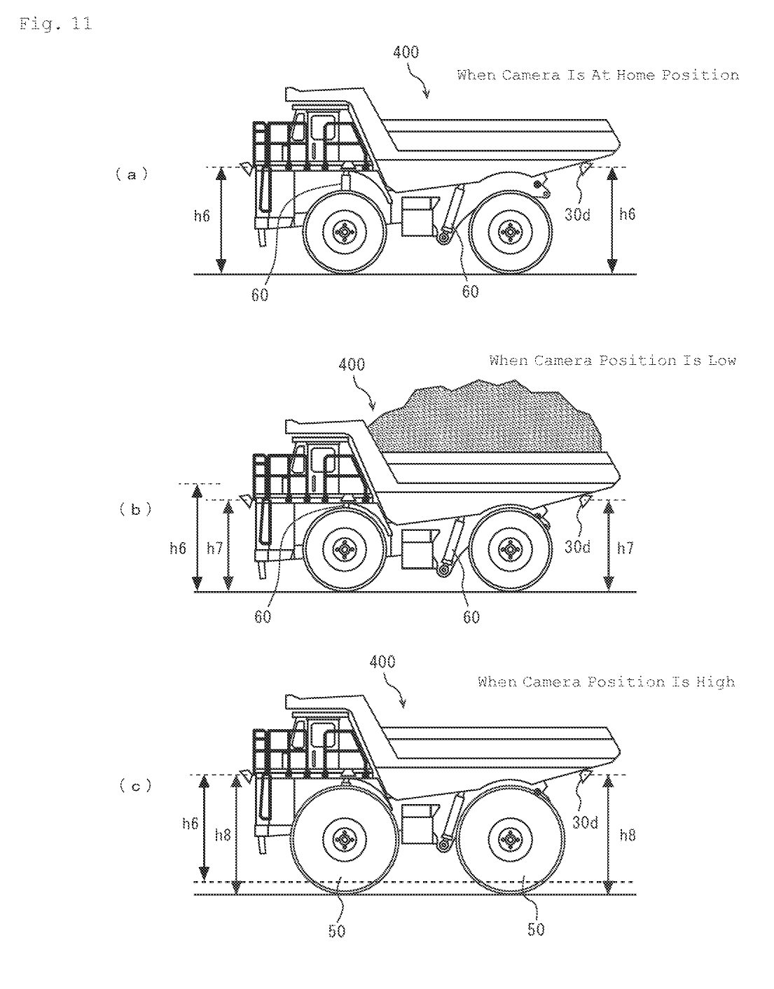

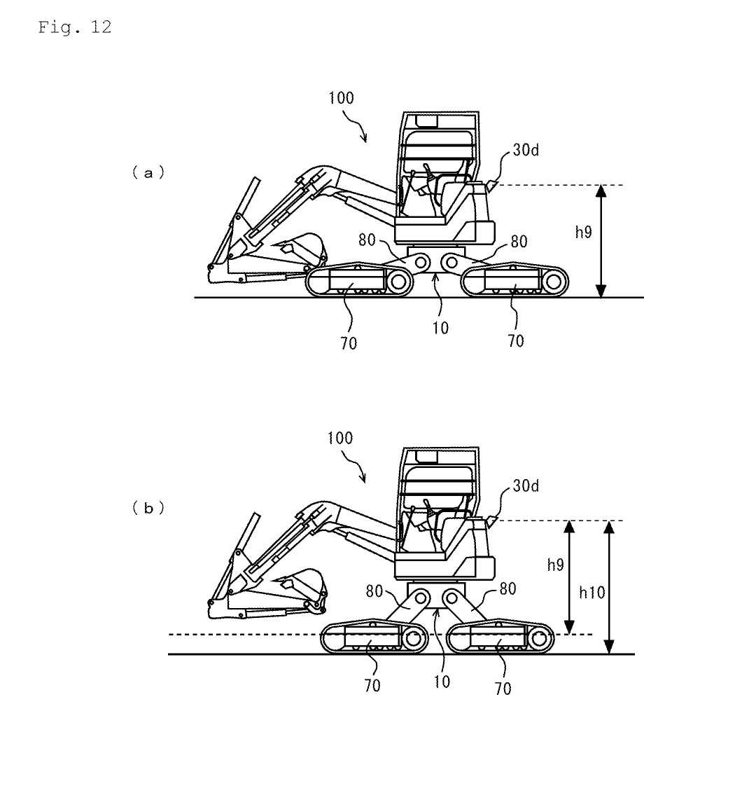

FIG. 11a to 11c illustrate examples when the machinery is a dump truck 400. FIG. 11a shows when the dump truck has no loadage, and FIG. 11b shows when the dump truck has full loadage thereon. The height of the camera 30d is h6 in FIG. 11a, and the height of the camera is h7 in FIG. 11b. Thus, the height of the camera 30d becomes lower as the entire vehicle body takes a lower position due to the weight of the loadage on the dump truck. Therefore, when the dump truck has the loadage, the cut region e-w is selected which is larger than the cut region e-n for the dump truck having no loadage. FIG. 11c shows an example when the dump truck has large-diameter tires 50 than the tires 50 shown in FIG. 11a. The height of the camera 30d in FIG. 11c is higher than when the smaller tires are mounted on the dump truck as shown in FIG. 11a. Therefore, the cut region e-s is selected which is smaller than the cut region e-n for the smaller tires (FIG. 11a).

FIGS. 12a and 12b illustrate examples when the machinery is a power shovel 100 equipped with four crawlers. The four-crawler power shovel 100 has four independent crawlers 50 as its lower traveling unit 10, and is able to alter the heights of the respective crawlers 50 to deal with a rough (uneven) road or ground surface. In case of such four-crawler power shovel 100, the camera height h9 of the power shovel 100 when the support legs 80 of the crawlers 70 are open as shown in FIG. 12a is different several tens cm from the camera height h10 of the power shovel 100 when the support legs 80 of the crawlers 70 are closed as shown in FIG. 12b. In case of such four-crawler power shovel 100, therefore, the most appropriate cut region e is calculated and selected based on the height of the camera.

When the adjustments of the cut regions e of the upper viewpoint images 35 are finished in the above-described manner, the display controller proceeds to the next step, Step S110. At Step S110, the cut regions e of the upper viewpoint images 35 are combined (synthesized) to prepare a bird's eye view image 300. Then, the display controller proceeds to the next step, Step S112. At Step S112, the prepared bird's eye view image 30 is displayed on the monitor screen 221, and the display controller proceeds to the last step, Step S114. It is determined at Step S114 whether the engine is deactivated or not. When it is determined that the engine is deactivated (YES), the display controller terminates the processing. When it is determined that the engine is not deactivated (NO), the display controller returns to the first step and repeats the above-described processing.

As described above, when the surroundings monitor device 200 of the present invention synthesizes the upper viewpoint images 35, which are derived from the original images 31 photographed by the cameras 30a, 30b, 30c and 30d, to prepare the bird's eye view image 300, the cut regions e of the respective upper viewpoint images 35 are adjusted on the basis of the heights of the cameras 30a, 30b, 30c and 30d prior to the synthesizing of the upper viewpoint images. As a result, even if the height of the vehicle body 20 changes greatly and the camera positions change, it is still possible to always prepare and display an appropriate bird's eye view image 300.

It should be noted that although the laser range finders 241 are used as the means for detecting the heights of the cameras 30 in this embodiment, the camera heights may be detected on the basis of the altered vehicle body information, such as the type of the lower traveling body 10 and tire size, and/or the weight of the loadage. For example, when the upper swinging body 20 is not altered and the lower traveling body 10 is only altered as shown in FIGS. 9a and 9b, it is possible to obtain accurate heights of the cameras by only entering the type of the lower traveling body 10 to the surroundings monitor device at the initial setting process if the type and size (height) of the lower traveling body 10 as well as other necessary information are stored in the memory in advance, in the form of database. When the outriggers 40 are activated as shown in FIGS. 10a and 10b, the camera heights may be calculated from the cylinder strokes of the outriggers 40.

In the case of FIGS. 11a-11c, the types and sizes (heights) of usable tires may be stored in the memory in advance in the form of database, and it may be possible to obtain accurate camera heights by only entering the manufacturer' s name and type of the tires upon changing the tires. Such vehicle body information may be entered by means of, for example, the input part 222 of the surroundings monitor unit 220. Alternatively, load gages or indicators may be installed on suspension elements 60 or other components that support the vehicle body, as shown in FIG. 11a, and the loadage may be detected. The camera heights may be then detected on the basis of the relationship between the detected loadage weight and an amount of downward movement (reduced height) of the vehicle body due to the loadage. If the above-mentioned various types of height detecting units are used in combination, the camera heights may be detected more accurately.

Alternatively, an operator may manually measure the heights of the cameras 30, and directly enter the measured values from the input part 222 of the surroundings monitor unit 220. Although the vehicle body image G representative of the power shovel 100 is displayed at the center of the bird's eye view image 300, the independent trapezoidal display areas S1-S4 are formed around the vehicle body image G (in front of and behind the vehicle body image as well as on the right and left of the vehicle body image), and the cut images e1-e4 are displayed in the associated display areas S1-S4 respectively in the illustrated embodiment as shown in FIGS. 6, 7b and 7b, the position of the vehicle body image G representative of the power shovel 100 is not necessarily limited to the center of the bird's eye view image 300. For example, the display position of the vehicle body image G representative of the power shovel 100 may be shifted toward the front of the bird's eye view image 300 and the right and left display areas S1 and S2 and the rear display area S4 may be enlarged, or the display position of the vehicle body image G representative of the power shovel 100 may be shifted toward the upper left of the bird's eye view image 300 and the display areas S1 and S4, which are particularly difficult for visual recognition, may be enlarged.

### REFERENCE NUMERALS AND SYMBOLS

100: Power shovel (machinery)
200: Surroundings monitor device
210: Display controller
211: Camera position detector (camera position detection means)
212: Upper viewpoint image preparation unit (upper viewpoint image preparing means)
213: Bird's eye view image preparation unit (bird's eye view image preparing means)
214: Range finder
220: Surroundings monitor display (display means)
300: Bird's eye view image
20: Upper swinging body (vehicle body)
30, 30a, 30b, 30c, 30d: Cameras (photographing means)
31: Original image
35: Upper viewpoint image
e, e1 to e4: Cut-out regions
FIG. 1
FIG. 2
221 Monitor Unit
210 Display Controller
213 Bird's Eye View Image Preparation Unit
212 Upper Viewpoint Image Preparation Unit
211 Camera Position Detector
214 Laser Range Finder
FIG. 3
FIG. 4
FIG. 5a
FIG. 5b
FIG. 5c
Cut Region e-n When Camera Is At Home Position
Cut Region e-w When Camera Position Is Low
Cut Region e-s When Camera Position Is High
FIG. 6
When Camera Is At Home Position
FIG. 7a
When Camera Position Is High
FIG. 7b
When Camera Position Is Low
FIG. 8
Start
S100 Photograph Vehicle Body Surroundings
S102 Prepare Upper Viewpoint Images
S104 Detect Camera Positions
S106 Are Cameras At Home Positions?
S108 Adjust Upper Viewpoint Images
S110 Prepare Bird's Eye View Image
S112 Display Birds'Eye View Image
S114 Engine Stopped?
End
FIG. 9a
When Camera Is At Home Position
FIG. 9b
When Camera Position Is Low
FIG. 9c
When Camera Position Is High
FIG. 10a
When Camera Is At Home Position
FIG. 10b
When Camera Position Is High
FIG. 11a
When Camera Is At Home Position
FIG. 11b
When Camera Position Is Low
FIG. 11c
When Camera Position Is High
FIG. 12a
FIG. 12b

What is claimed is:

1. A surroundings monitoring device installed on machinery that changes its vehicle body height, comprising:
a plurality of cameras mounted on the vehicle body of the machinery for photographing surroundings of the machinery;
upper viewpoint image preparation means for applying an upper viewpoint conversion process on an original image, which is photographed by each of the cameras, to prepare an upper viewpoint image of each said camera;
bird's eye view image preparation means for synthesizing the upper viewpoint images, which are prepared by the upper viewpoint image preparation means, to prepare a bird's eye image of the surroundings which includes an image representing the machinery;
display means for displaying the bird's eye view image prepared by the bird's eye view image preparation means; and
camera position detection means for detecting positions of the cameras mounted on the vehicle body, the bird's eye view image preparation means being configured to synthesize display areas of the upper viewpoint images, which are prepared by the upper viewpoint image preparation means, based on heights of the cameras detected by the camera position detection means.

2. The surroundings monitoring device for machinery according to claim 1 further including a range finder for measuring a vertical distance between a ground surface, on which the vehicle body is present, and each of the cameras, wherein the camera position detection means detects the positions of the cameras based on the vertical distances between the ground surface and the cameras which are respectively measured by the range finder.

3. The surroundings monitoring device for machinery according to claim 1 further including an input part for entry of vehicle body information, wherein the camera position detection means detects the positions of the cameras based on the vehicle body information entered from the input part.

4. The surroundings monitoring device for machinery according to claim 1 further including a gravimeter for measuring a weight of loadage on the vehicle body, wherein the camera position detection means detects the positions of the cameras based on the weight of the loadage measured by the gravimeter.
